(19) United States
(12) Patent Application Publication
(10) Pub. No.: US 2026/0355757 A1
(43) Pub. Date: Nov. 12, 2026

(54) SHOWERHEAD ASSEMBLY WITH WATER FILTER

(71) Applicant: Aqua Tru, LLC, Sherman Oaks, CA (US)

(72) Inventors: Peter Spiegel, Sherman Oaks, CA (US); Michael Pedersen, Sherman Oaks, CA (US); Jassimran Arora, Sherman Oaks, CA (US); Kunpeng Li, Dungguan (CN)

(21) Appl. No.: 19/667,762

(22) Filed: May 5, 2026

Related U.S. Application Data
(60) Provisional application No. 63/802,966, filed on May 9, 2025.

(51) Int. Cl. B05B 1/18; C02F 1/00

(52) U.S. Cl. CPC B05B 1/18; C02F 1/003; C02F 2307/06

(57) ABSTRACT

A showerhead assembly including an upstream housing, a downstream housing, and a filter is disclosed. The filter may act as a coupling means between the upstream housing and the downstream housing. Specifically, the filter may be connected to the upstream housing via a first locking mechanism and to the downstream housing via a second locking mechanism. In some instances, the upstream housing and the downstream housing may not be directly connected with each other.

### CROSS-REFERENCE TO RELATED APPLICATIONS

The present application claims priority to and the benefit of US provisional application No. 63/802,966, filed May 9, 2025, which is hereby incorporated by reference herein in its entirety.

### FIELD

The present disclosure relates to a showerhead assembly and more specifically to a showerhead assembly with a water filter.

### BACKGROUND

Residential and commercial buildings typically include showers or bathtubs equipped with showerheads for bathing. A showerhead receives a supply of water from a utility water source or a water storage and disperses the received water in a shower. A conventional showerhead includes a plurality of components including, but not limited to, a ball joint that connects with a water supply pipe and allows for angle adjustment of the showerhead, a nozzle plate or a shower faceplate that disperses the water in the shower, a body or a housing that holds the showerhead’s internal components, one or more watertight seals or O-rings that prevent water leakage, and/or the like.

Typical showerheads are configured to dispense unfiltered tap water from the utility or other water source. Many users would prefer filtered water be dispensed from the showerhead. Thus, efforts are being made to add additional components and/or features to the showerheads, such as water filters, which may enhance the experience of the user and convenience of operating the showerheads.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a side view of an example first showerhead assembly in accordance with the present disclosure.

FIG. 2 depicts a cross-sectional view of the first showerhead assembly in accordance with the present disclosure.

FIG. 3 depicts a cross-sectional view of an example second showerhead assembly in accordance with the present disclosure.

FIG. 4 depicts an isometric cross-sectional view of the second showerhead assembly in accordance with the present disclosure.

FIG. 5 depicts a cross-sectional view of an example downstream housing and a filter in accordance with the present disclosure.

FIG. 6 depicts a flow diagram of an example method to make a showerhead assembly in accordance with the present disclosure.

### DETAILED DESCRIPTION

### Overview

The present disclosure describes an apparatus or a showerhead assembly (“showerhead”) that filters the water that is received from a utility water source or a water storage and outputs filtered water to the shower. The showerhead may include a first housing (e.g., an upstream housing), a second housing (e.g., a downstream housing), and a filter. The upstream housing and the downstream housing may collectively form a showerhead housing or cover that encloses a plurality of showerhead components, such as the filter when the first and second housing are assembled together. For example, the filter may be enclosed within the upstream housing and the downstream housing when the showerhead is assembled.

In some aspects, the filter may act as a coupling means between the upstream housing and the downstream housing, which may not be directly connected with each other. Specifically, the filter may be connected with the upstream housing via a first locking mechanism and with the downstream housing via a second locking mechanism. The first locking mechanism may be similar to or different from the second locking mechanism. Example structures of the first and second locking mechanisms are briefly described below.

In an exemplary aspect, the first locking mechanism may include an elongated horizontal protrusion on a top portion of the filter and an L-shaped bracket on a top portion of the upstream housing. The filter may connect with the upstream housing when the elongated horizontal protrusion engages with the L-shaped bracket. In some aspects, the elongated horizontal protrusion may include a first locking lip at its proximal end. Further, the L-shaped bracket may include a first elongated part and a second elongated part that may be aligned parallel to each other and disposed at a predefined distance away from each other such that a gap may exist between the first elongated part and the second elongated part. A proximal end of the first elongated part may include a second locking lip, which may have a shape complementary to the shape of the first locking lip.

The first elongated part may move between a bent position and an unbent position (which may be the default position of the L-shaped bracket). When the user desires to connect the filter with the upstream housing, the user may insert the elongated horizontal protrusion into the L-shaped bracket, which may cause the first elongated part to move to the bent position (due to the width of the elongated horizontal protrusion) via the gap described above. When the elongated horizontal protrusion is fully inserted into the L-shaped bracket, the first locking lip may snap-fit with the second locking lip and the first elongated part may return to the unbent position, thereby securing the elongated horizontal protrusion in the L-shaped bracket. In this manner, the filter may be attach to the upstream housing when the showerhead is assembled.

In some aspects, the second locking mechanism may include a first threaded portion on a bottom portion of the filter and a second threaded portion on a top portion of the downstream housing. The filter may connect with the downstream housing when the first threaded portion engages with the second threaded portion. For example, the downstream housing may be threaded onto the filter when the showerhead assembled.

In additional aspects, the showerhead may include a push button configured to enable a rotation of the downstream housing relative to the upstream housing when the push button is pressed and disable the rotation of the downstream housing relative to the upstream housing when the push button is released. When the user desires to replace the filter from the showerhead, the user may press the push button and then rotate the downstream housing relative to the upstream housing to disengage the filter from the downstream housing. When the filter is disengaged from the downstream housing, the user may rotate the filter relative to the upstream housing to disengage the filter from the upstream housing. Thereafter, the user may connect a new filter to the upstream housing and the downstream housing in the same manner as described above. When the new filter is engaged with the downstream housing and the upstream housing, the push button may automatically get “locked” into its default position (i.e., the released position), thereby disabling the rotation of the downstream housing relative to the upstream housing and securing the filter in the showerhead.

The showerhead may further include a securing fixture or a ball joint that enables a connection between the upstream housing and a water supply pipe that receives water from the utility water source, the water storage, or other water source. The showerhead may additionally include a shower faceplate or a nozzle plate that outputs water in the shower. The faceplate may be connected to the downstream housing.

During operation, water may be received by the upstream housing from the utility water source or the water storage via the securing fixture. The received water may be fed to the filter, which may clean the water and transfer the clean water towards the downstream housing. The clean water received by the downstream housing may be dispersed or sprayed in the shower by the faceplate.

The present disclosure discloses a showerhead assembly that is easy to assemble and disassemble. The showerhead includes a filter that filters the water received from the utility water source, the water storage, or other water source and provides filtered water in the shower. Further, the user may conveniently connect or replace the filter to / from the showerhead by simply rotating the filter relative to the upstream housing and the downstream housing. In this manner, the user is not required to use any external tools to replace the filter or assemble the showerhead, thereby considerably enhancing the user convenience and experience of using the showerhead.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

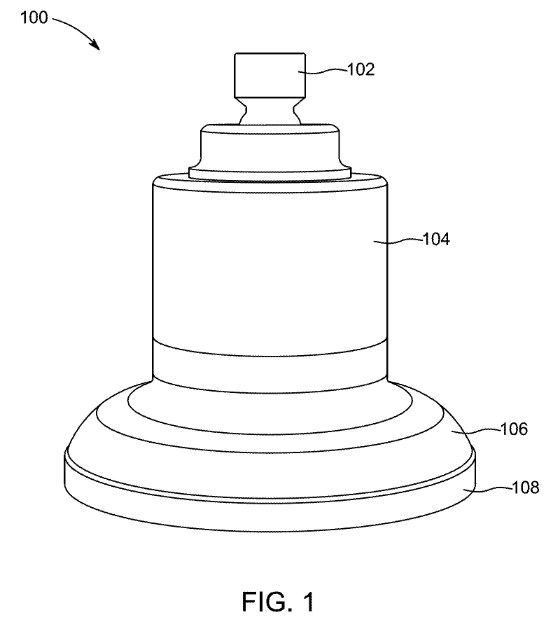

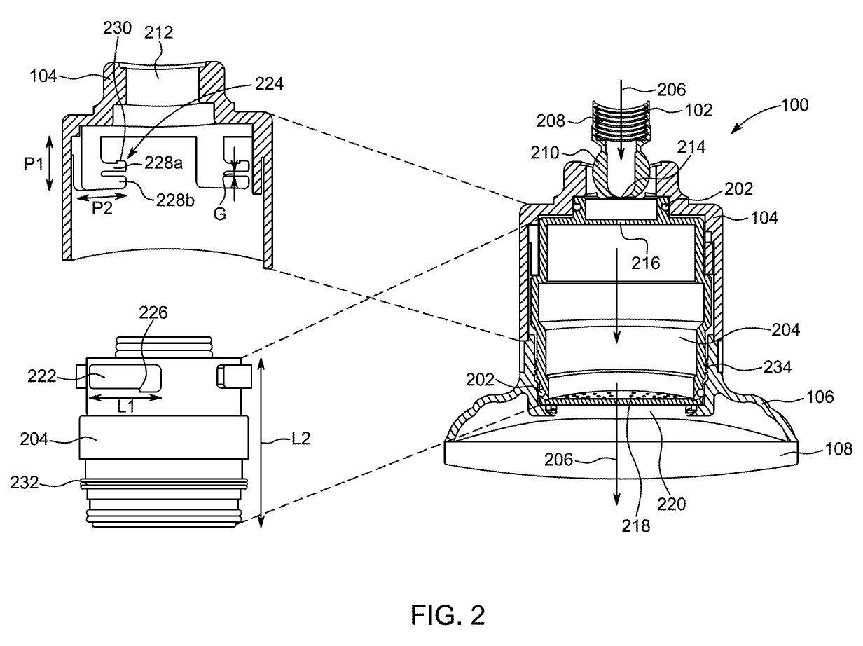

FIG. 1 depicts a side view of an example first showerhead assembly 100 (or an apparatus 100 / showerhead 100) in accordance with the present disclosure. FIG. 1 will be described in conjunction with FIG. 2. The showerhead 100 may be installed in a residential, commercial, or industrial facility or building. The showerhead 100 may receive a supply of water from a utility water source or a water storage and may spray or disperse the received water in a shower. The showerhead may receive water from any suitable water source.

The showerhead 100 may include a plurality of components including, but not limited to, a securing fixture 102 (or a ball joint), an upstream housing 104, a downstream housing 106, a shower faceplate 108 (or a nozzle plate), one or more watertight seals or O-rings 202 (shown in FIG. 2), and/or the like. It is known that water obtained from a water source may contain contaminants, such as bacteria, arsenic, metals, compounds, chlorine, etc. As health awareness is growing, there is a desire amongst users to remove such contaminants from the water before the water contacts the user’s skin. To ensure that the water that is dispersed from the showerhead 100 is filtered and substantially devoid of relevant contaminants, the showerhead 100 may additionally include a filter 204 that may be removably attached to an interior portion of the showerhead 100. The filter 204 may filter or clean the water that is received from the water source and then output the clean water to the shower via the faceplate 108. An example flow of water is shown by arrows 206 in FIG. 2 and described later below.

As shown in FIG. 2, a top interior portion 208 of the securing fixture 102 may be threaded, and a bottom portion 210 of the securing fixture 102 may be or include a ball joint or the like. The threaded portion of the securing fixture 102 may be connected to a water supply pipe (not shown) that transfers water from the water source to the showerhead 100. Further, the ball joint may be connected to a top end 212 of the upstream housing 104 and may allow for angle adjustment of the upstream housing 104 (and hence the showerhead 100) relative to the water supply pipe. In this manner, the upstream housing 104 may be connected to the securing fixture 102 (that in turn is connected to the water supply pipe).

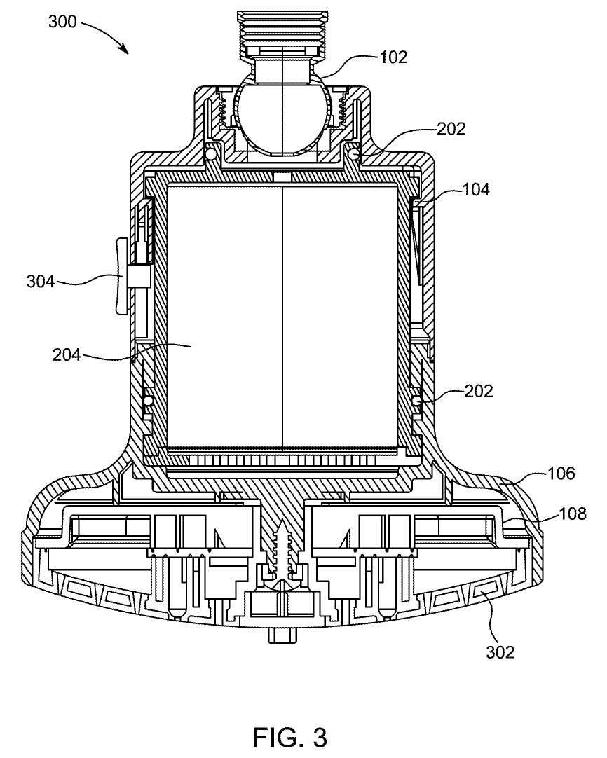

The securing fixture 102 may receive water from the water supply pipe and output the received water to the filter 204 via a first opening 214 in the securing fixture 102. The filter 204 may include one or more top openings 216, which may receive the water from the securing fixture 102 and transfer the water to the interior portion of the filter 204. The water may get filtered in the filter interior portion, and the filtered or clean water may exit the filter 204 via one or more bottom openings 218. The downstream housing 106 may include a second opening 220 that may receive the clean filtered water from the bottom openings 218 and may transfer the water to the faceplate 108. In some aspects, the downstream housing 106 may be connected / attached to the faceplate 108. In other instances, the downstream housing 106 and the faceplate 108 may be a single unitary component. The faceplate 108 may include a plurality of discharge apertures (shown as apertures 302 in FIGS. 3-5) through which the water received from the second opening 220 may be dispensed or sprayed in the shower.

In this manner, the water that is received from the water source is filtered in the showerhead 100, and the clean water is dispensed in the shower. Description of the structural components of the showerhead 100 and their connections is described below.

In some aspects, the upstream housing 104 and the downstream housing 106 may collectively form a showerhead housing or outer cover that encloses different showerhead components such as the ball joint / securing fixture 102, the filter 204, the faceplate 108, and/or the like. In some aspects, the upstream housing 104 and the downstream housing 106 may not be directly connected or attached to each other, but rather the filter 204 may act as a coupling means between the upstream housing 104 and the downstream housing 106, as described below. In alternative aspects, in addition to the filter 204 acting as a coupling means, the upstream housing 104 and the downstream housing 106 may also be connected with each other via one or more additional locking means. The present disclosure describes an aspect where the upstream housing 104 and the downstream housing 106 are not connected with each other via any locking means; however, such description should not be construed as limiting.

In the exemplary aspect depicted in FIGS. 1 and 2, the upstream housing 104, the downstream housing 106, and the filter 204 are cylindrical in shape. Such a shape enables a user to conveniently rotate these components relative to each other as required. For example, the filter 204 may be rotated relative to the upstream housing 104 and/or the downstream housing 106 to secure the filter 204 in the showerhead 100, as described below.

In certain embodiments, the filter 204 may be connected to the upstream housing 104 via a first locking mechanism, and to the downstream housing 106 via a second locking mechanism. Since the filter 204 is connected to the upstream housing 104 and the downstream housing 106, the filter 204 acts as a coupling means between the upstream housing 104 and the downstream housing 106, and thus these two housings may not require any separate internal or external locking means. In some aspects, when the upstream housing 104 and the downstream housing 106 are coupled via the filter 204, a flush finish may form at the intersection point of the exterior surfaces of the upstream housing 104 and the downstream housing 106, as shown in FIG. 1.

In some aspects, the first locking mechanism (through which the filter 204 connects with the upstream housing 104) and the second locking mechanism (through which the filter 204 connects with the downstream housing 106) may be similar to each other in structure and function. In other aspects, the first locking mechanism and the second locking mechanism may be different from each other in structure and function. FIG. 2 illustrates (and the description below describes) an embodiment where the first and second locking mechanisms are different from each other; however, such depiction should not be construed as limiting.

In one exemplary aspect, the first locking mechanism may include one or more elongated protrusions 222 on a top exterior portion of the filter 204 and one or more L-shaped brackets 224 on a top interior portion of the upstream housing 104. In some instances, the elongated protrusions 222 may be perpendicular to the longitudinal axis of the filter 204 and may curve about the exterior surface of the filter 204. A count of horizontal protrusions 222 in the filter 204 may be equivalent to a count of L-shaped brackets 224 in the upstream housing 104. The filter 204 may connect with the upstream housing 104 when the horizontal protrusions 222 engage with the L-shaped brackets 224.

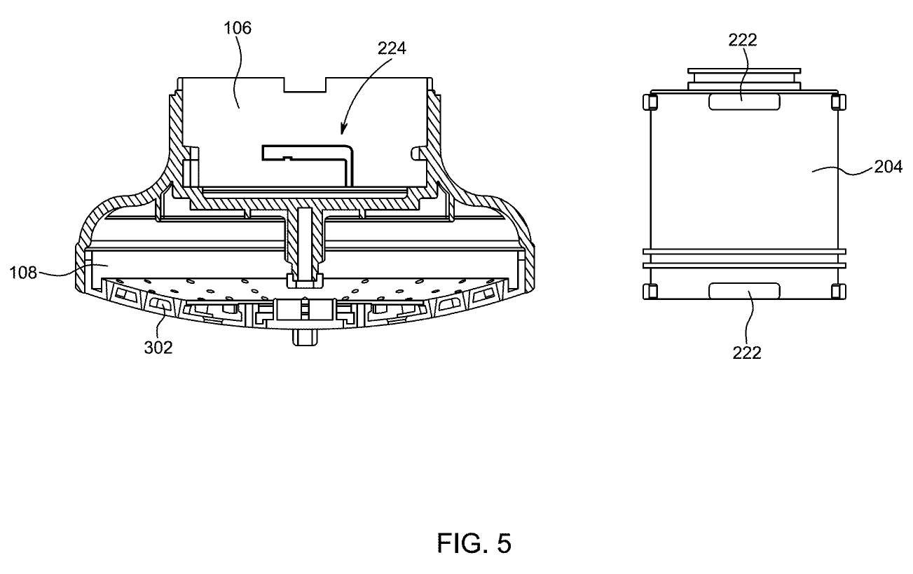

In an exemplary aspect, a longitudinal axis “L1” of each elongated protrusion 222 may be perpendicular to a longitudinal axis “L2” of the filter 204. A length of each elongated protrusion 222 may be in a range of 5-20% of a circumference of the filter 204. The elongated protrusions 222 may be any suitable size, shape, or configuration. Further, each elongated protrusion 222 may include a proximal end and a distal end. In one exemplary aspect, the proximal end may include a first locking lip 226 (which may be a downward extended tapered end, as shown in FIG. 2) and the distal end may be flat (i.e., may not include any locking lip). In another exemplary aspect (as shown in FIG. 5 and described later below), the proximal end may also be flat and may not include any locking lip. Stated another way, the presence of the locking lip is not mandatory in the elongated protrusion 222. In some instances, the corners of the elongated protrusions 222 may be rounded.

Furthermore, each L-shaped bracket 224 may include a first portion “P1” and a second portion “P2,” where “P1” may be perpendicular to “P2”, as shown in FIG. 2. “P2” may be aligned perpendicular to a longitudinal axis of the upstream housing 104 and the longitudinal axis “L2”. In some aspects, the second portion “P2” may include a first elongated part 228a and a second elongated part 228b that may be aligned parallel to each other and disposed at a predefined distance away from each other such that an elongated gap “G” may exist between the first elongated part 228a and the second elongated part 228b. In an exemplary aspect, a proximal end of the first elongated part 228a may include a second locking lip 230, which may be complementary in shape to the first locking lip 226 and configured to engage with the first locking lip 226.

The filter 204 may be connected with the upstream housing 104 when the user inserts the elongated protrusion 222 into the L-shaped bracket 224 and the first locking lip 226 engages or snap-fits with the second locking lip 230. In some aspects, the first elongated part 228a may be configured to move between a bent (or flexed) position and an unbent position (which may be the default position of the first elongated part 228a). When the user inserts the elongated protrusion 222 into the L-shaped bracket 224, the first elongated part 228a may bend or flex towards the second elongated part 228b via the gap “G” (thereby moving to the bent position) due to the width of the elongated protrusion 222. The first elongated part 228a may return to the unbent position when the first locking lip 226 snap-fits with the second locking lip 230, thereby securing the elongated protrusion 222 in the L-shaped bracket 224. In this manner, the filter 204 connects or “snap-fits” with the upstream housing 104 via the first locking mechanism.

As described above, the first locking mechanism may be the same as or different from the second locking mechanism. When the first locking mechanism is different from the second locking mechanism, in an exemplary aspect, the second locking mechanism may include a first threaded portion 232 on a bottom portion of the filter 204 and a second threaded portion 234 on a top portion of the downstream housing 106. The filter 204 may connect with the downstream housing 106 when the first threaded portion 232 engages with (screwed on) the second threaded portion 234.

In operation, the user may connect the securing fixture 102 (that may already be connected with the upstream housing 104) with the water supply pipe. The user may further insert the elongated protrusion 222 into the L-shaped bracket 224 to connect the filter 204 with the upstream housing 104. The user may additionally screw and engage the first threaded portion 232 with the second threaded portion 234 to connect the filter 204 with the downstream housing 106 (that may already be connected with the faceplate 108). In this manner, the user may assemble the showerhead 100, without having to directly connect the upstream housing 104 with the downstream housing 106. Such an assembling process of the showerhead 100 is convenient and does not require use of any external tools to connect the upstream and downstream housings 104, 106. The user may follow a similar process to conveniently replace the filter 204 with a new filter, when the old filter requires replacement.

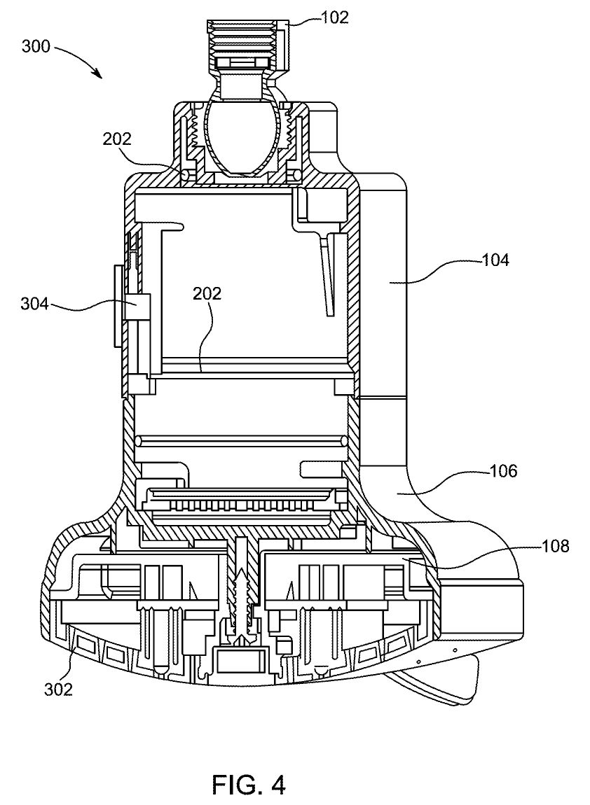

FIG. 3 depicts a cross-sectional view of an example second showerhead assembly 300 (or showerhead 300) in accordance with the present disclosure. FIG. 3 will be described in conjunction with FIGS. 4 and 5.

The showerhead 300 may be similar to the showerhead 100 described above; however, the downstream housing 106 of the showerhead 300 may also include the L-shaped bracket 224 (as shown in FIG. 5), similar to the upstream housing 104. Consequently, the first locking mechanism and the second locking mechanism may be the same in the showerhead 300. Furthermore, in the showerhead 300, both the top portion and the bottom portion of the filter 204 may include the elongated protrusions 222 (as shown in FIG. 5), which may engage with the L-shaped brackets 224 to connect the filter 204 with the upstream housing 104 and the downstream housing 106.

As depicted in FIG. 5, in the showerhead 300, the L-shaped bracket 224 may not include the first and second elongated parts 228a, 228b or locking lips. Similarly, the elongated protrusion 222 may not include locking lips. In this case, the filter 204 may be connected with the upstream/downstream housing 104, 106 when the user inserts the elongated horizontal protrusion 222 into the L-shaped bracket 224 (without having to snap-fit the first and second locking lips as described above in conjunction with the showerhead 100). Therefore, it may be appreciated that the presence of the first and second elongated parts 228a, 228b and the first and second locking lips 226, 230 is not mandatory for efficient coupling of the filter 204 with the upstream/downstream housing 104, 106.

In an exemplary aspect, the showerhead 300 may additionally include a push button 304 (as shown in FIGS. 3 and 4) that may be located at the upstream housing 104 or the downstream housing 106 or located partially in both the upstream and downstream housings 104, 106. The push button 304 may enable a rotation of the downstream housing 106 relative to the upstream housing 104 when the push button 304 is pressed and disable the rotation of the downstream housing 106 relative to the upstream housing 104 when the push button 304 is released (which may be the default position of the push button 304).

During operation, when the user desires to replace the filter 204 from the showerhead 300, the user may press the push button 304 and then rotate the downstream housing 106 relative to the upstream housing 104 to unscrew / uncouple / disengage the filter 204 from the downstream housing 106. When the filter 204 is disengaged from the downstream housing 106, the user may rotate the filter 204 relative to the upstream housing 104 to unscrew / uncouple / disengage the filter 204 from the upstream housing 104. Thereafter, the user may connect a new filter to the upstream and downstream housings 104, 106 in the same manner as described above. When the new filter is screwed / engaged with the upstream housing 104, the push button 304 may automatically get “locked” into its default position (i.e., the released position), thereby disabling the rotation of the downstream housing 106 relative to the upstream housing 104 and securing the filter 204 in the showerhead 300.

In some instances, the push bottom 304 may be used as a slide button. That is, the push bottom 304 may slide along the longitudinal axis of the showerhead 300 for engaging and disengaging the various components of the showerhead 300 apart and together. For example, the push bottom 304 may slide up towards the water inlet to lock the various components together or slide down towards the shower face plate.

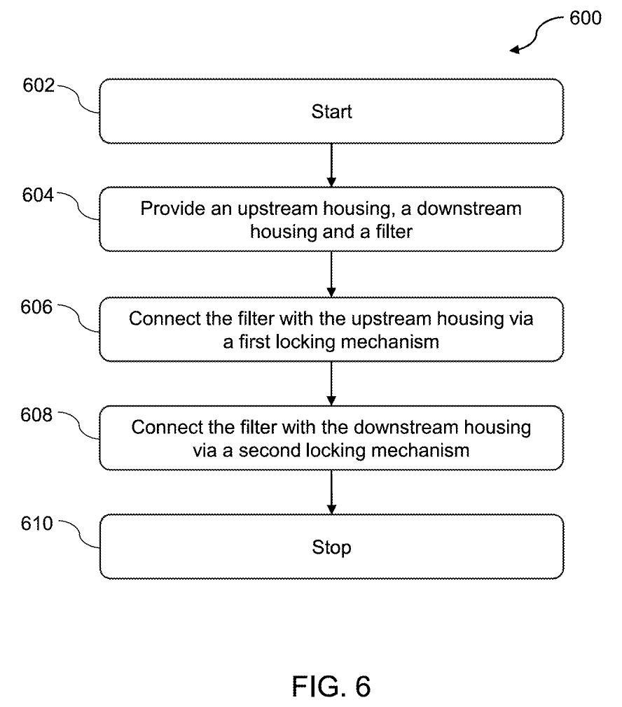

FIG. 6 depicts a flow diagram of an example method 600 to make or assemble the showerhead assembly 100 in accordance with the present disclosure. FIG. 6 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 600 starts at step 602. At step 604, the method 600 may include providing the upstream housing 104, the downstream housing 106 and the filter 204. At step 606, the method 600 may include connecting the filter 204 with the upstream housing 104 via the first locking mechanism. At step 608, the method 600 may include connecting the filter 204 with the downstream housing 106 via the second locking mechanism. As described above, the filter 204 acts as a coupling means between the upstream housing 104 and the downstream housing 106, which may not be directly connected with each other.

The method 600 may end at step 610.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A showerhead assembly comprising:
a first housing;
a second housing; and
a filter, wherein the filter is connected to the first housing via a first locking mechanism, and wherein the filter is connected to the second housing via a second locking mechanism.

2. The showerhead assembly of claim 1, wherein the first housing is an upstream housing and the second housing is a downstream housing.

3. The showerhead assembly of claim 2, wherein the upstream housing is configured to be connected to a securing fixture that connects with a water supply pipe, and wherein the downstream housing is configured to be connected to a shower faceplate that outputs water.

4. The showerhead assembly of claim 2, wherein the first locking mechanism comprises a protrusion on a top portion of the filter and an L-shaped bracket on a top portion of the upstream housing, and wherein the filter connects with the upstream housing when the protrusion engages with the L-shaped bracket.

5. The showerhead assembly of claim 4, wherein the protrusion comprises an elongated protrusion and a longitudinal axis of the elongated horizontal protrusion is perpendicular to a longitudinal axis of the filter.

6. The showerhead assembly of claim 5, wherein the elongated horizontal protrusion comprises a proximal end and a distal end, and wherein the proximal end comprises a first locking lip.

7. The showerhead assembly of claim 6, wherein:
the L-shaped bracket comprises a first portion and a second portion,
the second portion is perpendicular to the first portion,
the second portion is aligned perpendicular to a longitudinal axis of the upstream housing,
the second portion comprises a first elongated part and a second elongated part,
the first elongated part and the second elongated part are aligned parallel to each other and at a predefined distance from each other such that a gap exists between the first elongated part and the second elongated part, and
a proximal end of the first elongated part comprises a second locking lip.

8. The showerhead assembly of claim 7, wherein the filter connects with the upstream housing when the elongated horizontal protrusion is inserted into the L-shaped bracket, and the first locking lip engages with the second locking lip.

9. The showerhead assembly of claim 8, wherein the first elongated part is configured to move between a bent position and an unbent position, wherein the first elongated part bends towards the second elongated part via the gap when the elongated horizontal protrusion is inserted into the L-shaped bracket, and wherein the first elongated part returns to the unbent position when the first locking lip snap fits with the second locking lip.

10. The showerhead assembly of claim 1, wherein the first locking mechanism is similar to the second locking mechanism.

11. The showerhead assembly of claim 1, wherein the first locking mechanism is different from the second locking mechanism.

12. The showerhead assembly of claim 2, wherein the second locking mechanism comprises a first threaded portion on a bottom portion of the filter and a second threaded portion on a top portion of the downstream housing, and wherein the filter connects with the downstream housing when the first threaded portion engages with the second threaded portion.

13. The showerhead assembly of claim 2, further comprising a push button configured to enable a rotation of the downstream housing relative to the upstream housing when the push button is pressed, and disable the rotation of the downstream housing relative to the upstream housing when the push button is released.

14. A showerhead assembly comprising:
an upstream housing;
a downstream housing; and
a filter, wherein:
the filter is connected to the upstream housing via a first locking mechanism,
the filter is connected to the downstream housing via a second locking mechanism,
at least one of the first locking mechanism or the second locking mechanism comprises an elongated horizontal protrusion of the filter and an L-shaped bracket of the upstream housing or the downstream housing, and
the filter connects with the upstream housing or the downstream housing when the elongated horizontal protrusion engages with the L-shaped bracket.

15. The showerhead assembly of claim 14, wherein the first locking mechanism is similar to the second locking mechanism.

16. The showerhead assembly of claim 14, wherein at least one of the first locking mechanism or the second locking mechanism comprises a first threaded portion of the filter and a second threaded portion of the downstream housing or the upstream housing, and wherein the filter connects with the downstream housing or the upstream housing when the first threaded portion engages with the second threaded portion.

17. The showerhead assembly of claim 14, wherein a longitudinal axis of the elongated horizontal protrusion is perpendicular to a longitudinal axis of the filter.

18. The showerhead assembly of claim 14 further comprising a push button configured to enable a rotation of the downstream housing relative to the upstream housing when the push button is pressed, and disable the rotation of the downstream housing relative to the upstream housing when the push button is released.

19. A method for making a showerhead assembly comprising:
providing an upstream housing, a downstream housing, and a filter;
connecting the filter with the upstream housing via a first locking mechanism; and
connecting the filter with the downstream housing via a second locking mechanism.

20. The method of claim 19, wherein at least one of the first locking mechanism or the second locking mechanism comprises an elongated horizontal protrusion of the filter and an L-shaped bracket of the upstream housing or the downstream housing.
